(19) United States
(12) Patent Application Publication
(10) Pub. No.: US 2024/0173649 A1
(43) Pub. Date: May 30, 2024

(54) METHODS TO DRAWDOWN PIPE SECTIONS WITH THE USE OR REGULATION CONTROL OF FLARING AND CROSS-COMPRESSION TECHNIQUE

(71) Applicants: Ronald Williams, Kingwood, TX (US); Sam Edwards, Houston, TX (US); Joe Chandler, Houston, TX (US); Cameron Brasier, Spring, TX (US)

(72) Inventors: Ronald Williams, Kingwood, TX (US); Sam Edwards, Houston, TX (US); Joe Chandler, Houston, TX (US); Cameron Brasier, Spring, TX (US)

(21) Appl. No.: 18/519,029

(22) Filed: Nov. 26, 2023

Related U.S. Application Data
(60) Provisional application No. 63/428,135, filed on Nov. 28, 2022.

(51) Int. Cl. B01D 17/02; F23G 7/08

(52) U.S. Cl. CPC B01D 17/0214; F23G 7/08

(57) ABSTRACT

A method to drawdown pipe sections with the use or regulation control of flaring and cross-compression technique. The method allows to evacuate a fluid mixture from a drawdown section. The fluid mixture typically contains a liquid phase and a gas phase. The method includes flowing the fluid mixture from the drawdown section towards a separation vessel, and then out of the separation vessel to simultaneously flow the gas phase towards a flare for burning and flow the liquid phase towards one or more pumps towards an adjoining section. The proposed method allows recovering a higher proportion of the fluid mixture, as recycled product, and therefore limiting the combustion of the gas phase towards the atmosphere.

### BACKGROUND

The field of use includes the draw-down or de-inventory of pipeline sections, such as transmission and gathering lines in the midstream sector. Typical pipeline sections may contain Liquefied Petroleum Gas, abbreviated as LPG, or Highly Volatile Liquid, abbreviated as HVL. The pipelines may therefore contain a mixture of liquid and gas, as well as any intermediate phases between liquid and gas.

Pipelines may need a draw-down operation for various reasons, including the routine maintenance for issues like valve replacement, corrosion or damage repair to the pipe. Other needs may include operational requirements like to tie-in connections for an addition of lateral pipelines, relocations of existing pipelines to facilitate other utilities or infrastructure. Other needs may also include inspections such as pressure testing or cutting out stuck inline inspection tools, idling pipelines when not in use for long periods or abandonment at the end of its service life.

A typical existing method used to perform a LPG or HVL pipeline draw-down or de-inventory operation is to use a dual phase flare stack designed to burn the evacuated fluids. During this process, the flare typically initially receives 100% liquid phase until the product pressure in the pipeline section reaches its vapor pressure. At this point, the flare receives a multi-phase fluid defined as a mix of liquid and vapor phase, because the product may cold-boil in the pipeline. At some point during this process, the percentage of vapor will far exceed the liquid in the line. At this stage, the flare will receive significantly more vapor along with low volume slugs of liquid. Slug flow is caused by the vapor flowing faster thru the flare than the liquid thereby causing wave action of the liquid left in the pipe. This fast-flowing vapor pushes the liquid wave up from the below the grade or ground level of the pipeline, up to the flare connection above grade. Since the liquid then slows the flow to the flare, the vapor velocity in the pipe slows causing the wave to fall back down to the lower portions of the pipeline causing the process to repeat until no liquid is left or until there is so little liquid; the vapor velocity is not high enough to bring the liquid up to the connection point. Many variables may control this slugging action including diameter of the pipe, vapor pressure of the product, elevation changes of the pipe and capacity of the flare system to flow these fluids and vapors.

When using this existing method, most of the product in the pipeline may be treated as waste and consumed by the flare. Therefore, most value of the product inside the pipeline may be lost and the combustion of the entire volume of product within the pipeline may increase the amount of released emission in the atmosphere.

Another existing prior art may include using a multi-phase cross-compression unit to pump product from one pipeline section being de-inventoried into an adjacent section of pipeline or vessel. These units are most effective during the stage when they are receiving liquids as the density is higher than the gas or vapor phase, thereby moving more product with each stroke of the compressor. Though, once the cross-compression unit no longer receives liquids, the effectiveness drops off significantly and the process becomes dependent on the expansion ratio of the product and its vapor pressure. For example, the expansion ratio of propane is 270:1, therefore the compressor would need to pump 270 cubic feet of vapor to equal 1 cubic foot of liquid de-inventoried product. Conversion effects may also be part of the process as with varying pressures, liquid volume may become gas volume as the pressure inside some pipe section is decreasing, for example due to the movement of fluids caused by the cross-compression unit.

When using this method, most of the product in the pipeline may be recovered, though this method may have a limitation on longer sections of pipeline, typically above 5000 ft [1500 m]. Using this method on longer section of pipeline, the time required for draw-down may typically be above 36 hours per 1000 ft [300 m] of pipeline. This time required may be cost prohibitive for some operations as it would keep the pipeline out of service during the drawdown operation, resulting in a low efficiency method.

### BRIEF DESCRIPTION OF THE DRAWINGS

For a more detailed description of the embodiments of the disclosure, reference will now be made to the accompanying drawings.

FIG. 1 represents a schematic of the components and connections related to the proposed invention.

FIG. 2 represents a detailed view around the separation vessel and possibility to link a level indicator or level controller.

FIG. 3 represents a detailed view of multiple fluid pumps possibility with multiple fluid pumps in series or parallel on the fluid flowline.

FIG. 4 represents a schematic of some parameters relevant for the proposed invention linked with a proposed schematic and arrangement of components.

FIG. 5 represents a possible regulation flow diagram linked with the proposed invention.

### DETAILED DESCRIPTION

It is to be understood that the following disclosure describes several exemplary embodiments for implementing different features, structures, or functions of the invention. Exemplary embodiments of components, arrangements, and configurations are described below to simplify the disclosure; however, these exemplary embodiments are provided merely as examples and are not intended to limit the scope of the invention.

Even if advantages and other features will become apparent from the following schematics, description and proposed claims, the proposed list of advantages may be limiting.

The proposed invention process may use a combination of some elements of the two methods described in the existing art section, while adding specific usage, features and control method.

One advantage of the proposed invention would be to capture as much product as practical from the drawdown pipeline, while completing the draw-down in the same time frame as a typical flaring operation would take. The proposed invention may therefore result in a higher proportion of product recovery from the drawdown pipeline, typically between 40% and 80%, while limiting the combustion of hydrocarbon product in the atmosphere, and while keeping the reduced time of straight flaring operation. Overall, the proposed invention may improve both the financial and environmental aspects of the drawdown operation.

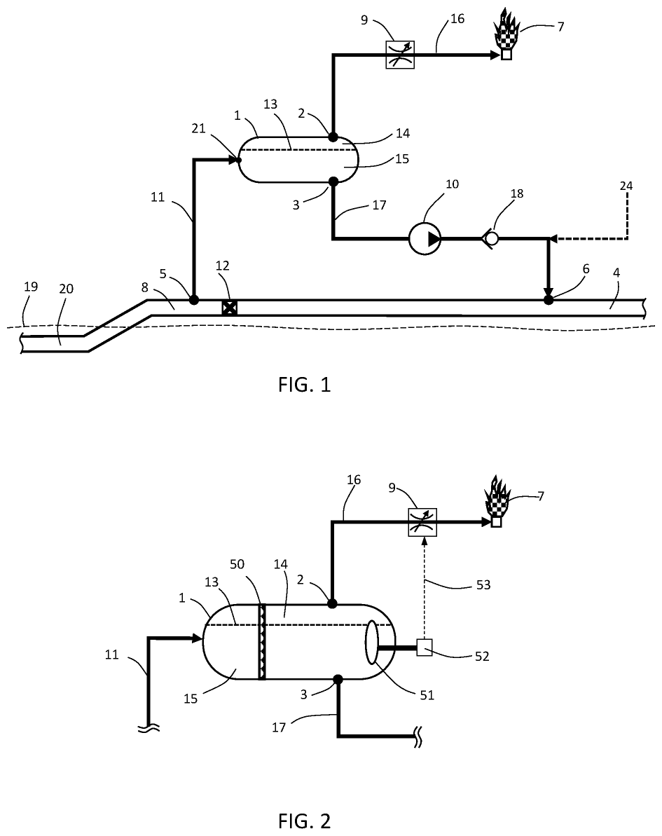

Following item numbers refer to the FIGS. 1 to 5, which are depicting the proposed invention.

As depicted in FIG. 1, the proposed application process may include a separation vessel 1, inline between a drawdown section 8 and a flare 7.

The separation vessel 1 may allow the flare 7 to operate at constant high velocity rates only receiving gas or vapor from a vessel top connection 2, typically located at the top of the separation vessel 1.

Typically, the drawdown section 8 would be considered as the section intended to be de-inventoried or drawn down. The drawdown section 8 may have the shape of a pipeline or a hose, as depicted in FIG. 1, or may have the shape of a tank or a vessel. The drawdown section 8 may be filled with a fluid mixture of liquid and gas. The composition of the fluid mixture may depend on the fluid composition, such as its chemistry, the pressure and the temperature present inside the drawdown section 8. The gas may also be designated as vapor. Typically, the transition from liquid to gas will occur at different pressure and temperature for the different components of the fluid mixture. For example, at room temperature, typical liquid to gas transition may occur around 450 psi [3.1 MPa] for double Carbon components, or C2s, such as methane, at around 120 psi [0.8 MPa] for triple Carbon components, or C3s, such as propane, and at around 40 psi [0.28 MPa] for quadruple Carbon components, or C4s, such as butane.

The flare 7 would be a device to combust, oxidize or vent a waste product, such as vapors or gas. A gas phase 14 would be typically present on the upper section within the separation vessel 1. The gas phase 14 may flow through a vessel top connection 2 and through a flare section 16. The flare 7 may also be designated as flare stack, combustor, incinerator, thermal oxidizer, burner, vent stack, stack pipe or riser.

A flow line 11 may connect the drawdown section 8 to the separation vessel 1 at a flow connection feed-in 21. The flow line 11 may be typically linked to the drawdown section 8 through a drawdown section connection 5. The drawdown section connection 5 may be a tie-in point on the pipeline of the drawdown section 8 allowing flowing the mixture of liquid and gas inside the flow line 11.

The separation vessel 1, also designated as knock-out tank, or gas buster, or slug catcher, or trap tank, may have the shape of a barrel or tank. The longest vessel dimension may be oriented either towards a vertical axis or towards a horizontal axis. In FIG. 1, the separation vessel 1 is represented with the longest dimension towards a horizontal axis. The typical function of the separation vessel 1 would be to separate a liquid phase 15 from the gas phase 14, present within the separation vessel 1. A liquid to gas level within the separation vessel 1 would be symbolized as a level 13. The level 13 may represent the interface, typically as a flat plane in static or semi-static conditions, representing the top of the volume of the liquid phase 15 and therefore the bottom of the gas phase 14, withing the separation vessel 1. Typically, the gas phase 14 would have a smaller volumetric mass density compared to the liquid phase 15.

Different types of separation vessel 1 may be used, such as mechanical, gravity or centrifugal. The usage, shape and types of separation vessel 1 may depend on the proportion of fluid versus gas to be separated, the types of fluid or gas such as the expansion ratio between liquid and gas, the quantities of mixture being separated, the time and capacity of operation, the environment parameters such as pressure and temperature.

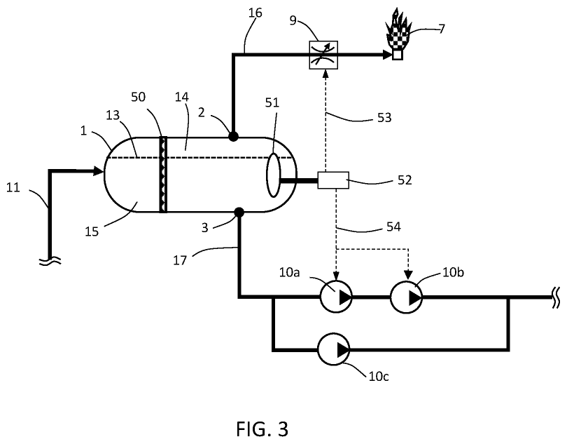

The liquid phase 15 may be pumped out of the separation vessel 1 from a vessel bottom connection 3, typically located at the bottom or at a lower point of the separation vessel 1. A liquid pump 10 or a group of liquid pumps 10, as further described in FIG. 3, may move the liquid phase 15 present inside the separation vessel 1 into an adjoining section 4.

The one or multiple liquid pumps 10 may be operated manually, remotely, or automated. Each liquid pump 10 may be operated through pneumatic, pressure, electrical, mechanical, or hydraulic means. The type of each liquid pump 10 may include a piston pump, a screw pump, a diaphragm pump, a centrifugal pump, a gear pump, a lobe pump, a metering pump, a progressive cavity pump, a plunger pump or multi-phase pump. The one or multiple liquid pumps 10 would displace the liquid phase 15 at a rate, typically between 0 and 3 BPM [0 to 0.5 m3/min].

As for the drawdown section 8, the adjoining section 4 may have the shape of a pipeline as depicted in FIG. 1, or the shape of a tank or vessel. The adjoining section 4 may itself be connected to a secondary adjoining vessel, not shown in FIG. 1, which would be used as a recovery vessel. The adjoining section 4 would receive the liquid phase 15 as a fluid product to be reclaimed in the process. The liquid phase 15, after flowing through the vessel bottom connection 3 would flow through a liquid flowline 17. The liquid flowline 17 may include the liquid pump 10 and a check valve 18, before reaching an adjoining section connection 6 to tie-in with the adjoining section 4. The check valve 18 would prevent the liquid phase 15 from flowing back towards the separation vessel 1, after being moved by the one or multiple liquid pumps 10 towards the adjoining section 4.

The adjoining section 4 may be separated from the drawdown section 8 by a pipe line block valve 12. The pipeline block valve 12 would typically be closed during draw down operation to prevent direct flow between the mixture contained within the drawdown section 8 and the mixture, typically fluids, contained within the adjoining section 4. The adjoining section 4 and the drawdown section 8 may also not be in line with each other's, and may be two separate or distinct sections of tanks, tubulars, vessels, hoses, and may not need the pipeline block line valve 12 as a separation.

The gas phase 14 may flow out of the separation vessel 1 through the vessel top connection 2, and may flow through a flare section 16, typically as a discharge flow and may not need a dedicated pump. The flow of gas within the flare section 16 towards the flare 7 may be controlled by a flow control valve 9.

The flow control valve 9 may a device or group of devices to restrict or control the flow of gas flowing to the flare 7 through the flare section 16. The flow control valve 9 may be operated manually, remotely or automated. The operation mode of the flow control valve 9 may be through pneumatic, pressure, electric, mechanical, hydraulic or manual means. The flow control valve 9 may be designated as regulator, choke, throttle valve, float valve, gate valve, globe valve, butterfly valve, pinch valve, diaphragm valve, reducing valve, regulator valve or needle valve.

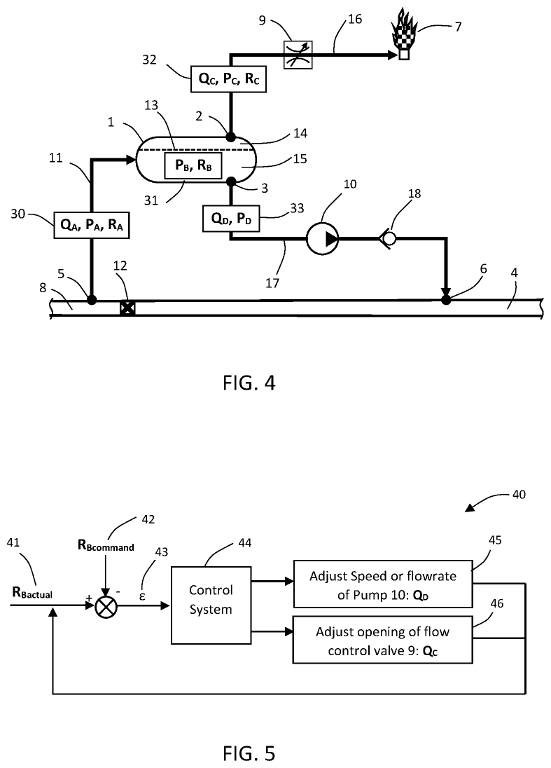

The flow of gas through the flare line 16, controlled by the flow control valve 9, may influence the separation efficiency of the separation vessel 1 and may in turn influence the flowrate of the flow line 11 pulling typically a mixture of gas and liquid from the draw down section 8. The objective of the process may be to keep the flowrate out of the draw down section 8 as high as possible, while keeping operating within the limits of the flare 7, including for example the pressure, velocity, smoke, heat, within the flare 7. Keeping a high flowrate out the draw down section 8 would also keep a high flowrate of the fluid phase 15 flowing through the liquid flowline 17. The gas flow through the flare section 16 to the flare 7 may be reduced or shut off, if the capacity of the liquid pump 10 cannot regulate the level 13 within the separation vessel 1. An over-proportion of the liquid phase 15 inside the separation vessel 1 may conduct the liquid phase 15 to flow to the flare 7, which would typically be avoided. Another parameter to regulate with the flowrate to the flare 7 may be the pressure within the separation vessel 1. A higher pressure in the separation vessel 1 would minimize vaporization. Additional regulation of the level 13 may be necessary if the evaporation process increases inside the separation vessel 1, requiring increasing the flowrate inside the flare section 16, through the flow control valve 9, towards the flare 7. As the proportion of the fluid inside the drawdown section 8 continues to decrease or pressure within the flow line 11 continues to drop below a critical point, typically below the vapor pressure of the fluid mixture, it may be necessary to further adjust the gas or liquid flowrates, through the flow control valve 9 or liquid pump 10, to ensure the highest proportion of the drawdown mixture from the drawdown section 8 remains in liquid phase. Process parameters and a regulation method are proposed within FIG. 4-5.

In FIG. 1, grade 19 may represent the ground level. A below-grade section 20 may be present below grade 19, typically between 3 to 30 ft [1 to 10 m] below ground level. A possible wave effect may appear in the below-grade section 20 in case of slug formation inside the drawdown section 8 as detailed in the existing art description.

An injection of inert gas may be added to the application process and is symbolized in FIG. 1 with a gas injection line 24. Inert gas such as nitrogen may be added through the gas injection line 24 to the liquid flowline 17 at the opposite end of the liquid pump(s) 10. The inert gas may assist in the movement of the liquid product to the end of the liquid flowline 17, where the liquid pump 10 may keep the product in a liquid state for a more efficient pumping operation.

FIG. 2 represents a detailed view of FIG. 1, in particular around the separation vessel 1, and depicts a possible variation compared to FIG. 1. As represented in FIG. 2, the separation vessel 1 may include a level indicator 50. The level indicator 50 may indicate visually the position of the level 13, showing the interface between the liquid phase 15 and gas phase 14. The level indicator 50 may correspond to the position of a floater linked to the fluid upper surface present inside the separation vessel 1.

As another variation, depicted in FIG. 2, a level controller 51 may be present within the separation vessel 1. The level controller 51 may include a sensing unit able determine the level 13 and indicate the amount of liquid phase 15 as well as gas phase 14, within the separation vessel 1. The level controller 51 may be linked to a float gauge as well as to other types of ultrasonic or pressure measurement to determine the level 13. The level controller 51 may be connected to an electronic recorder 52 or converter, which may convert the physical level 13 in a digital or electronic form. The electronic recorder 52 may itself be linked to a feedback connection 53 which may communicate for example with the flow-control valve 9. The feedback connection 53 may have the form of a wire connection or a wireless connection. The flow-control valve 9 may therefore include the parameters sent by the electronic recorder 52, allowing to adjust its opening or closing position based on the level 13 or other parameters recorded within or around the separation vessel 1, such as pressures, temperatures and flow-rates. Additional details regarding regulation possibilities are further described in FIG. 4-5.

FIG. 3 represents a variation to FIG. 1 regarding the liquid pump 10. More than one liquid pump 10 may be present. As non-limiting example, FIG. 3 includes two liquid pumps in series 10a and 10b, and one liquid pump in parallel 10c. Any combination of liquid pumps 10 in series or in parallel may be possible to obtain the desired flowrate and efficiency for the pumping through the liquid flowline 17. The combination of pumps 10 may also be arranged to allow the pumping of inert gas through the gas injection line 24. Therefore, and not represented, more than one gas injection lines 24 may be added to conform with the different branches of the liquid flowline 17 and the different combinations of liquid pumps.

FIG. 3 also represents a possible feedback connection 54 between the level controller 51 and the pumps 10a, 10b or 10c. The feedback connection 54 may be a wired connection or a wireless connection, and may have the ability to act on one or more of the fluid pumps 10a, 10b and 10c. The feedback connection 54 may therefore have an influence on some parameters of the fluid pump 10 or any combination of fluid pumps 10a. 10b or 10c. Parameters of the pump 10, as well as 10a, 10b or 10c, may include for example the discharge flowrate, the inlet and the outlet pressure, the fluid density.

FIG. 4 represents possible parameters present in the process, which may be used for a regulation method.

Parameters 30 represent the variables which may be significant for the flow section 11, between the drawdown section 8 and the separation vessel 1. Parameters 30 may be described as following:
Q_{A} would represent the flowrate of the fluid mixture including the liquid phase 15 and gas phase 14, further present within the separation vessel 1. Standard Q_{A} flowrate would typically be in the range from 0 to 1 million scf/hour, as standard cubic feet of gas per hour [0 to 28,000 cubic meters per hour];
P_{A} would represent the fluid mixture pressure within the flow section 11. Standard P_{A} pressure would typically be similar to the pressure within the drawdown section 8 and would vary through the drawdown process as the fluid transition from liquid phase to gas phase. To ensure maximum liquid phase, a typical pressure may be kept at 10% above the vapor pressure of the fluid mixture;
R_{A} would represent the ratio of liquid versus gas within the mixture flowing inside the flow section 11. A R_{A} of 1 would mean a full liquid mixture, and a R_{A} of 0 would mean a full gas mixture. Standard R_{A} ratio would typically be start as 1 with full liquid and transition through the drawdown process to 0 with full gas at the end.

Parameters 31 represent the variables which may be significant within the separation vessel 1. Parameters 31 may be described as the following:
P_{B} would represent the fluid mixture pressure within the separation vessel 1. Standard P_{B} pressure would typically be close to the pressure P_{A}, and may be kept at 10% above the vapor pressure of the fluid mixture;
R_{B} would represent the ratio of liquid versus gas within the separation vessel 1. A R_{B} of 1 would mean a full liquid mixture, and a R_{B} of 0 would mean a full gas mixture. The ratio R_{B} would relate directly to the level 13 within the separation vessel 1. The ratio R_{B} could be derived from the level indicator 50 or the level controller 51, as described in FIG. 2. Assuming the separation vessel 1 works in steady mode and within its recommended range, the fluid within the separation vessel 1 would be either in liquid form, as liquid phase 15 or in gas form, as gas phase 14, and both phases would typically fully fill the main volume of the separation vessel 1.

Parameters 32 represent the variables which may be significant for the flare section 16, between the top connection 2 of the separation vessel 1 and the flare 7. Parameters 32 may be described as the following:
Q_{C} would represent the flowrate of the gas flowing inside the flare section 16. Standard Q_{C} flowrate would typically be in the range of 0 to 1 million scf/hour, as standard cubic feet of gas per hour [0 to 28,000 cubic meters per hour];
P_{C} would represent the gas pressure within the flare section 16. Standard P_{C} pressure would typically be in the range of 0 psi to 250 psi [0 to 1.7 MPa];
R_{C} would represent the ratio of liquid versus gas within the mixture flowing inside the flare section 16. A R_{C} of 1 would mean a full liquid mixture, and a R_{C} of 0 would mean a full gas mixture. Standard R_{C} ratio would typically be close to 0, as the highest proportion of gas would be recommended to flow inside the flare section 16 to reach the flare 7, and avoid operation or safety issues.

Parameters 33 represent the variables which may be significant for the liquid flowline 17, between the bottom connection 3 of the separation vessel 1 and the adjoining section 4. Parameters 33 may be described as the following:
Q_{D} would represent the flowrate of the liquid flowing inside the liquid flowline 17. Standard Q_{D} flowrate would typically be in the range of 1 to 3 BPM [0.16 to 0.5 cubic meter/minute];
P_{D} would represent the liquid pressure within the liquid flowline 17. Standard P_{D} pressure would typically be in the range of 1,000 psi to 2,000 psi [6.9 MPa to 13.8 MPa], depending on equipment type such as the liquid pump(s) 10 and the rating of the liquid flowline 17, as maximum allowable pressure for safe operation.

Note that by default, only liquid phase 15 would be present inside the liquid flowline 17.

FIG. 5 represents a regulation flow diagram as a part of the proposed invention.

A primary goal of the regulation method, represented as a regulation loop 40 in FIG. 5, as steady mode, includes regulating R_{B}, or the ratio of liquid versus gas within the separation vessel 1.

R_{Bactual} 41 would represent an input or actual measured ratio or level inside the separation vessel 1. R_{Bcommand} 42 would represent a target ratio or level considered as a command. R_{Bcommand} could include a wished ratio, typically between 0.4 to 0.6, as well as a R_{Bmin}, representing the minimum ratio for an optimum operation, and a R_{Bmax}, representing the maximum ratio for an optimum operation. A typical R_{Bmin} value may be between 0.1 and 0.3. A typical R_{Bmax} value may be between 0.7 and 0.9. The consequence of the R_{B} regulation may be to maintain Q_{A} high enough, pulling from the draw-down section 8, in order to maintain R_{B} above R_{Bmin} and therefore the necessary liquid phase 15 for the liquid pump(s) 10 to reclaim. The difference between R_{Bactual} 41 and R_{Bcommand} 42 would be calculated as the regulation difference & 43. A typical goal of the regulation loop 40 may be to keep the regulation difference & 43 as small as possible or within predetermined limits corresponding to the minimum and maximum wished ratio R_{Bmin} and R_{Bmax}.

Additional goals of regulation may include keeping Q_{C} as high as possible, keeping Q_{D} as high as possible, keep R_{B} as low as possible, i.e. maximum gas and mini liquid, or optimizing Q_{C} so that P_{B} is as high as possible to prevent vaporization.

The regulation loop may include R_{Bactual} 41 as input. A first output action 45 may be the adjustment of the speed or flow output of liquid pump(s) 10, which may directly influence Q_{C}. A second output action 46 may be the adjustment of the opening of the flow control valve 9 which may directly influence Q_{D}.

The regulation loop 40 may be controlled by a control system 44 performing at a predetermined frequency, either manual or automatic, typically between once every 1 second to once every 10 hours.

The electronic recorder 52 and the feedback connection 53 and 54, as depicted in FIG. 3, may be part of the control system 44. The control system 44 may automatically operate, regulate or adjust the opening of the flow control valve 9 as well as the speed or rate of the pump(s) 10, as depicted in the first output action 45 and in the second output action 46.

Other regimes may also be part of the regulation loop 40, with additional output and specific actions. Other regimes may include a start regime or an end regime. Example of a start regime, which may be performed as part of the process, may include the removal of contaminates such as air, nitrogen within the separation vessel 1. Other start regimes may include the purge of the flare 7 using product from the drawdown section 8. Example of end regimes may include opening the flow control valve 9 towards the flare 7 to its maximum, allowing the maximum flow of gas phase 14, in case for example if the level 13 is down below 0.25.

What is claim is:

1. A method to evacuate a fluid mixture from a drawdown section comprising:
flowing the fluid mixture from the drawdown section towards a separation vessel,
whereby the fluid mixture contains a liquid phase and a gas phase,
separating the fluid mixture in the liquid phase and the gas phase inside the separation vessel,
simultaneously flowing the gas phase towards a flare for burning and flowing the liquid phase through one or more pumps towards an adjoining section.

2. The method of claim 1, whereby flowing the gas phase towards the flare for burning, includes passing through a flow control valve.

3. The method of claim 1, wherein flowing the gas phase towards the flare for burning is characterized by a volumetric flow rate of the gas phase, and wherein flowing the liquid phase through the one or more pumps towards the adjoining section is characterized by a volumetric flow rate of the liquid phase.

4. The method of claim 3, whereby the liquid phase and the gas phase inside the separation vessel are delimited by a liquid level, whereby the liquid level represents the interface between the liquid phase and the gas phase, inside the separation vessel.

5. The method of claim 4, whereby the liquid level is controlled by adjusting the volumetric flow rate of the gas phase and by adjusting the volumetric flow rate of the liquid phase.

6. The method of claim 5, whereby adjusting the volumetric flow rate of the gas phase is achieved by operating the flow control valve.

7. The method of claim 6, whereby adjusting the volumetric flow rate of the liquid phase is achieved by operating the discharge rate of the one or more pumps.

8. The method of claim 7, whereby adjusting the volumetric flow rate of the liquid phase and adjusting the volumetric flow rate of the gas phase, is achieved through a regulation method.

9. The method of claim 8, whereby the regulation method is manual or automated.

10. The method of claim 8, whereby the regulation method achieves maintaining the liquid level inside the separation vessel at a wished level, or between a minimum or a maximum level,
wherein the liquid level is represented from a scale from 0 to 1, with 0 corresponding to 0% fluid phase and 100% gas phase, and 1 corresponding to 100% fluid phase and 0% gas phase.

11. The method of claim 10,
whereby the wished liquid level is between 0.4 and 0.6,
whereby the minimum liquid level is between 0.1 and 0.3,
whereby the maximum liquid level is between 0.7 and 0.9,
whereby the regulation method is updated at a frequency between 1 sec and 10 hours.

12. The method of claim 8, whereby the separation vessel includes a level indicator or a level controller, wherein the level indicator or the level controller allows determining the position of the liquid level.

13. The method of claim 12, whereby the level indicator or the level controller provides a feedback signal to operate the flow control valve or to operate the one or more pumps.

14. The method of claim 1, further comprising injecting an inert gas inside the liquid phase, after the liquid phase has been flowing through the one or more pumps, and whereby the injection flow direction of the inert gas is opposite compared to the flow direction of the liquid phase.

15. The method of claim 14, whereby the inert gas includes nitrogen.
